(19) United States
(12) Patent Application Publication
(10) Pub. No.: US 2009/0037235 A1
(43) Pub. Date: Feb. 5, 2009

(54) System that automatically identifies a Candidate for hiring by using a composite score comprised of a Spec Score generated by a Candidates answers to questions and an Industry Score based on a database of key words & key texts compiled from source documents, such as job descriptions

(76) Inventor: Anthony Au, Vancouver (CA)

Correspondence Address: FURR LAW FIRM, 2622 DEBOLT ROAD, UTICA, OH, 43080, US

(21) Appl. No.: 11/830,839

(22) Filed: Jul. 30, 2007

(51) Int. Cl. G06F 17/30

(52) U.S. Cl. 705/7

(57) ABSTRACT

A system that automatically identifies a Candidate for hiring by using a composite score comprised of a Spec Score generated by a Candidates answers to questions and an Industry Score based on key words & key texts from a source document, such as a job description. This system may reduce the time required to select a meaningful shortlist, as well as improving the compatibility of qualifications of candidates towards the requirements of a position by using a composite score. In doing so, the savings may result in reduction of both tangible and intangible costs currently incurred by an employer-company today.

### CROSS-REFERENCES TO RELATED APPLICATIONS (IF ANY)

None

### STATEMENT AS TO RIGHT TO INVENTIONS MADE UNDER FEDERALLY-SPONSORED RESEARCH AND DEVELOPMENT (IF ANY)

None

### BACKGROUND

1. Field of the Invention

The present invention relates to a data processing system automatically identifies candidates by using a composite score comprised of a Spec Score generated by the Candidates answers to questions and an Industry Score based on a database of key words & key texts compiled from source documents, such as job descriptions.

2. Description of Prior Art

Traditionally, recruiting requires constant interaction by individuals on both sides of the meeting table. This dynamic (human) interaction is of particular importance for senior management positions, say, at top levels of an organization and their first-line reports, where the matching process is often based on intangible, unique (to a particular management situation) and variable factors.

At the most senior management levels, recruitment will likely continue to be conducted with an evaluation process that revolves around constant interaction, based on real time interface between two parties.

But apart from the senior levels, recruitment of middle management and general staff positions, given their more prevalent responsibilities, are more reliant on common and standard data, through a matching process that requires less real time interaction. Recruitment at these levels are hence, more susceptible to automation.

To-date, automation on recruitment is predominantly represented by a passive display of static information on electronic poster boards similar in format and process to an electronic newspaper. The application of keyword searches is limited to a one-dimensional directory of data reference. Little value-add applications to the recruitment process are available in the recruiting automation services offered in the market today.

In addition, recruitment systems today often are matching ‘apples’ to ‘oranges’, due to the inconsistency of information supplied in the resumes of candidates and those requested in position specifications of hiring companies.

Until more relevant and consistent information can be captured, automated systems for recruitment will be confined to a simple display of limited, lower level positions, where relatively simple requirements can be standardized in a compatible format between the two parties involved in the recruitment process.

3. Prior Art

U.S. Pat. No. 6,754,874 by Richman and issued on Jun. 22, 2004, is for a computer-aided system and method for evaluating employees. It discloses a computer-aided method of evaluating personnel performance. The method includes the steps of making available to a user an electronic evaluation form, inputting a first set of data into the electronic form corresponding to the user, submitting the form including the first set of data for review to a second user and inputting a second set of data into the electronic form corresponding to the second user.

U.S. Pat. No. 6,662,194 by Joao and issued on Dec. 9, 2003, is for an apparatus and method for providing recruitment information. It discloses an apparatus and method for providing recruitment information, including a memory device for storing information regarding at least one of a job opening, a position, an assignment, a contract, and a project, and information regarding a job search request, a processing device for processing information regarding the job search request upon a detection of an occurrence of a searching event, wherein the processing device utilizes information regarding the at least one of a job opening, a position, an assignment, a contract, and a project, stored in the memory device, and further wherein the processing device generates a message containing information regarding at least one of a job opening, a position, an assignment, a contract, and a project, wherein the message is responsive to the job search request, and a transmitter for transmitting the message to a communication device associated with an individual in real-time.

U.S. Pat. No. 6,615,182 by Powers, et al. and issued on Sep. 2, 2003, is for a system and method for defining the organizational structure of an enterprise in a performance evaluation system. It discloses an organizational structure of an enterprise is defined in a performance evaluation system by storing a plurality of user-defined levels. A user-defined hierarchy is stored for the levels.

U.S. Pat. No. 6,385,620 by Kurzius, et al. and issued on May 7, 2002, is for a system and method for the management of candidate recruiting information. It discloses a system for automated candidate recruiting using a network includes a candidate web engine operable to communicate with the network and to present a candidate survey form to a client of the network, the candidate web engine further operable to receive candidate qualification data from the client that is entered in the form.

U.S. Pat. No. 6,381,592 by Reuning and issued on Apr. 30, 2002, is for a candidate chaser. It discloses a machine and method that automatically locate Internet site pages and web postings which contain operator specified keywords or Boolean combinations and then extracts all electronic mail addresses from those pages as well as hyper-linked pages to as many linking levels as selected by the operator and then sends a job opportunity description in the form of an electronic mail message to each of the extracted addresses then receives responses from recipients of the job opportunity message then filters those messages by reading their text and forwards only desired responses to the candidate seeking client's electronic mail address thusly sparing the client interaction with large amounts of irrelevant response while presenting viable candidates for a given job opening.

U.S. Pat. No. 6,370,510 by McGovern, et al. and issued on Apr. 9, 2002, is for an employment recruiting system and method using a computer network for posting job openings and which provides for automatic periodic searching of the posted job openings. It discloses a method and apparatus for providing an interactive computer-driven employment recruiting service. The method and apparatus enables an employer to advertise available positions on the Internet, directly receive resumes from prospective candidates, and efficiently organize and screen the received resumes.

U.S. Pat. No. 6,363,376 by Wiens, et al. and issued on Mar. 26, 2002, is for a method and system for querying and posting to multiple career websites on the internet from a single interface. It discloses a method and system for querying multiple career websites from a single interface is disclosed, where each of the websites comprises a plurality of web pages having site-specific fields requiring input of data. The method and system include collecting information from a user, and mapping the user information to the site-specific fields of each of the career websites.

U.S. Pat. No. 5,991,595 by Romano, et al. and issued on Nov. 23, 1999, is for a computerized system for scoring constructed responses and methods for training, monitoring, and evaluating human rater's scoring of constructed responses. It discloses systems and methods for presentation to raters of constructed responses to test questions in electronic workfolders.

U.S. Pat. No. 5,978,768 by McGovern, et al. and issued on Nov. 2, 1999, is for a computerized job search system and method for posting and searching job openings via a computer network. It discloses a method and apparatus for providing an interactive computer-driven employment recruiting service. The method and apparatus enables an employer to advertise available positions on the Internet, directly receive resumes from prospective candidates, and efficiently organize and screen the received resumes.

U.S. Pat. No. 5,884,270 by Walker, et al. and issued on Mar. 16, 1999, is for a method and system for facilitating an employment search incorporating user-controlled anonymous communications. It discloses a system for facilitating employment searches using anonymous communications includes a plurality of party terminals, a plurality of requester terminals, and a central controller.

U.S. Pat. No. 5,758,324 by Hartman, et al. and issued on May 26, 1998, is for a resume storage and retrieval system. It discloses a method of and apparatus for storage and retrieval of resume images in a manner which preserves the appearance, organization, and information content of the original document. In addition, summaries or “outlines” of resume images, broken down into multiple fields, are stored, and can be searched field by field.

U.S. Pat. No. 5,671,409 by Fatseas, et al. and issued on Sep. 23, 1997, is for a computer-aided interactive career search system. It discloses a method for accessing career information located in a computer database through interactive CD-ROM technology or other suitable computer-accessible means. The method involves the use of several levels of inquiry from which a user can select various careers, and for each career ask specific questions.

U.S. Pat. No. 5,164,897 by Clark, et al. and issued on Nov. 17, 1992, is for an automated method for selecting personnel matched to job criteria. It discloses an automated method for selecting personnel which includes the step of selecting a first set of employees having qualifications matching a first job criterion from a first data file where the first data file includes a first plurality of records and each record includes a first job selection criterion, such as job titles, and a corresponding employee code. A second step comprises selecting a second plurality of employees having qualifications matching a second job criteria from a second data file which includes a second plurality of records wherein each record includes a second job selection criteria, such as industrial experience, and a corresponding employee code.

The need for a better method for recruiting personnel in a manner that gives good matches to a company shows that there is still room for improvement within the art.

1. Field of the Invention

2. Description of Related Art Including Information Disclosed Under 37 CFR §1.97**>and 1.98<.

### SUMMARY OF THE INVENTION

The present invention relates to a data processing system that identifies a Candidate for hiring by using a composite score comprised of a Spec Score generated by a Candidates answers to questions and an Industry Score based on a database of key words & key texts compiled from source documents such as job descriptions.

The invention will reduce a substantial amount of time of conventional methods of recruitment, while increasing the accuracy in matching candidates with positions, at a fraction of the cost currently incurred by companies today.

The process is more efficient, effective, accurate and functional than the current art.

### GLOSSARY OF TERMS

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF THE DRAWINGS

Without restricting the full scope of this invention, the preferred form of this invention is illustrated in the following drawings:

FIG. 1 shows an overview of how a User accesses the system;

FIG. 2 shows a sample of the data;

FIG. 3 shows a flowchart of system flow; and

FIG. 4 shows a Composite Score being calculated.

### DESCRIPTION OF THE PREFERRED EMBODIMENT

There are a number of significant design features and improvements incorporated within the invention.

The present invention relates to a data processing system 1, engrained with value-added methodologies to create a highly structured and automated recruiting system. This system 1 may reduce the time required to select a meaningful shortlist, as well as improving the compatibility of qualifications of candidates towards the requirements of a position. In doing so, the savings may result in reduction of both tangible and intangible costs currently incurred by an employer-company today.

The system 1 uses a composite score to improve the selection process. The system 1 identifies a Candidate for hiring by using a composite score 700 comprised of a Spec Score 710 generated by a Candidates answers to questions and an Industry Score based on a database of key words & key texts compiled from source documents, such as job descriptions.

The system 1 is set to run a on a computing device 10. A computing device on which the present invention can run would be comprised of a CPU, Hard Disk Drive, Keyboard, Monitor, CPU Main Memory and a portion of main memory where the system resides and executes. A printer can also be included. Any general purpose computer with an appropriate amount of storage space is suitable for this purpose. Computer Devices like this are well known in the art and are not pertinent to the invention. The system can also be written in a number of different languages and run on a number of different operating systems and platforms. The system is network based and works on an Internet, Intranet and/or Wireless network basis as well as a stand alone system.

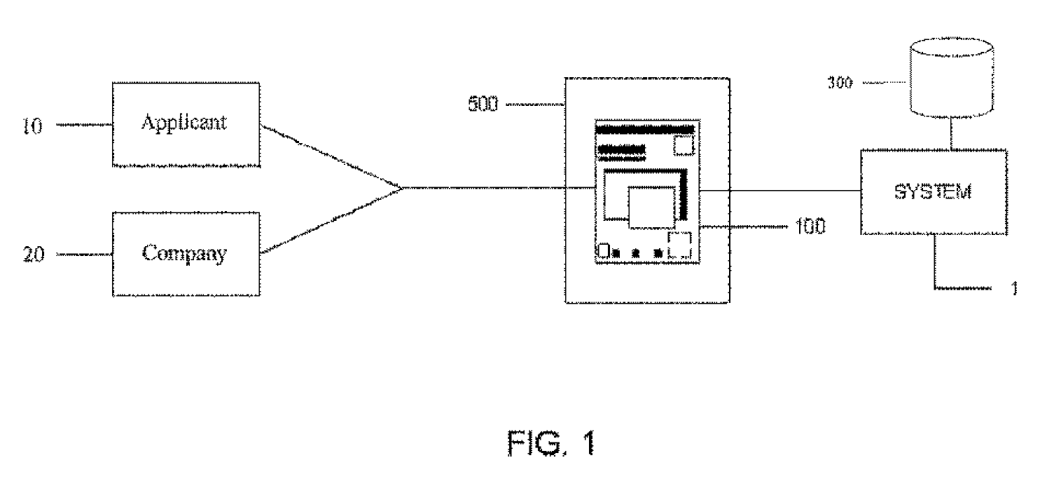

As shown in FIG. 1, the users 10 would access the system 1 through a network 100 or Internet 500. The system's software would reside in the system's memory 300. There are a number of different components of the system 1, these are described below.

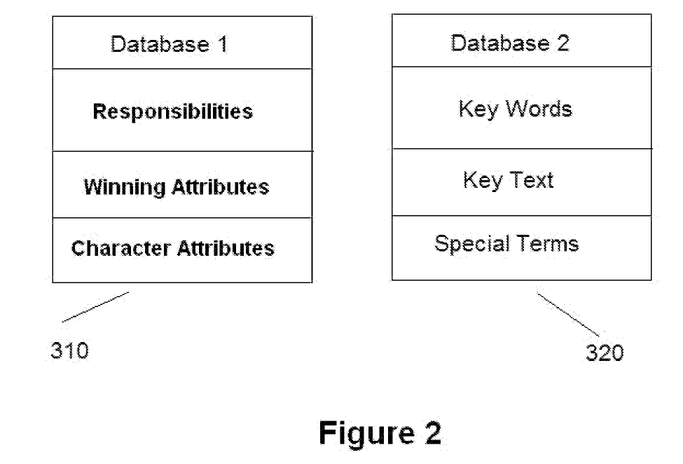

The system 1 uses a memory means 300 such as a standard hard drive or any other standard data storage device to store the data. A sample of the data is shown in FIG. 2.

The system 1 is a system that produces a composite score 700 that comprises matching with two separate and unrelated ‘references’.

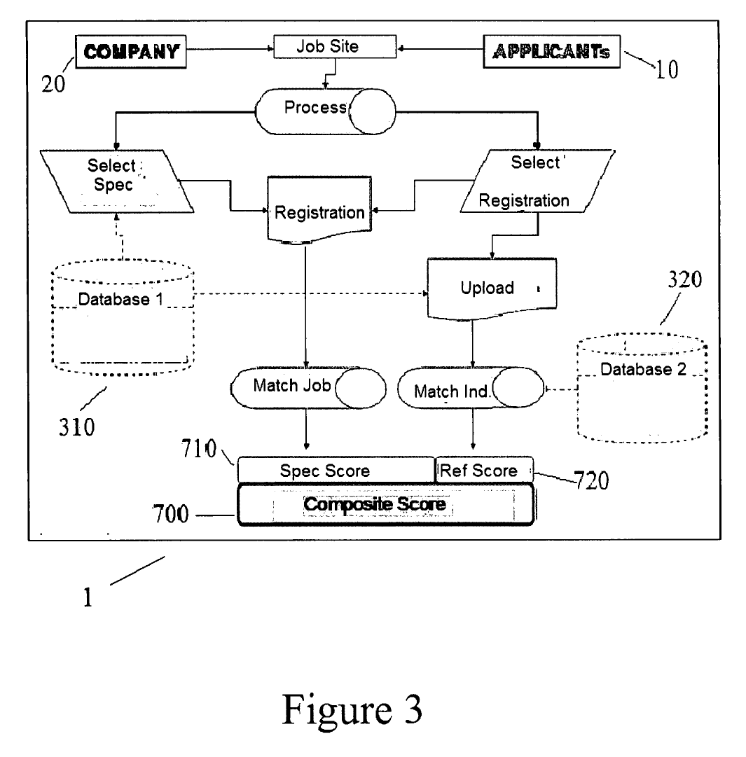

As shown in FIG. 3, the first is the Spec score 710 which is comprised of the match with a particular job specification which in the preferred embodiment accounts for 70% of composite score 700, but the system can change the percentage.

The Spec score 710 is produced by guiding the candidate 10 to choose from a group of criteria in a drop down box, which comprises a ‘mix’ of recruiter's specific requirements with other criteria from the same industry/job function combination. This involves a candidate choosing ‘hard’, specific data from a group and is set up similar to multiple choice test.

The system 1 refers to content of Database 310 of the system 1 which comprises specific vocabularies used by recruiters to build job specs. In the preferred embodiment, there are 3 categories: Responsibilities, Winning Attributes and Character Attributes as shown in FIG. 2.

The Candidate's 10 answers to the specific questions are organized in a top-down, goal-oriented structure, to drive out qualifications required and desired in a position to be recruited. In the preferred embodiment the systems uses the following criteria in which to measure the Candidate 10 for the position and to come up with a Spec score 710:
Goals or Major Responsibilities (set for each position);
Responsibilities (required to achieve each set goal or major responsibility);
Personal/Character Attributes (needed to discharge defined goals and responsibilities); and
Winning Attributes (additional qualifications needed to discharge defined goals and responsibilities).

The system 1 may also have “Gateway” Requirements which are basic prerequisites for a position that will need to be fulfilled before any further matching is conducted, such as: Academic qualifications (e.g. a university degree); Professional/vocational qualifications (e.g. Chartered Accountant, JAVA programmer); and Language (e.g. English).

The limitations of a one-dimensional directory of data (key-word) reference is improved by the application of fuzzy logic, as defined in the industry, in the matching of entire phrases/statements (e.g. to identify/develop/maintain customer relationships . . . ) and in the matching within context (e.g. ‘independent’ as a character attributes, as opposed to ‘independent dealers channel’ . . . ). Some of the fuzzy logic processes are disclosed in the following texts which are incorporated by reference, Artificial Intelligence by M. Negnevitsky, Fundamental of Neural Networks by L. Fausett, Genetic Algorithms by D. E. Goldberg and Machine Learning by T. M. Mitchell. The present invention uses some of the principles of fuzzy logic as published by L. A. Zadeh and discussed in U.S. Pat. No. 5,167,005 to Yamakawa filed on Aug. 11, 1989, U.S. Pat. No. 5,179,625 to Hisano filed on May 5, 1992, U.S. Pat. No. 5,724,488 by Prezioso and U.S. Pat. No. 5,577,169 also by Prezioso which are herein incorporated by reference in their entirety.

The second part of the composite score 700 is the industry score 720 which is a matching with market data, which in the preferred embodiment accounts for 30% of composite score with the percentage subject to change by the user of the system 1.

The reference score 720 is prepared from the parsing of a candidate's own uploaded CV or resume, and matching its contextual content against industry data of the specific industry/job function combination which is matching the candidate's own CV against the most commonly used, market job descriptions.

This involves the system 1 matching ‘soft’, general market data with the CV or resume of a candidate 10. The system 1 will refer to the content of Database 320 in the system, comprising commonly used vocabularies in the market, made up of:

Key words

Key text (phrases)

Special terms (relevant to a specific industry/job function combination, in 6 categories—Product, Company, Job Title, Job Function, School, Degree/Certification). This is displayed in FIGS. 2 and 3.

The system 1 will build a Key Word Library (KWL) 310 by identifying key words from Job Descriptions (JD). The system 1 will specify each JD based on a combination of the Industry (e.g. Garment) and Job Function (e.g. Accounting).

The system will compile a list of special terms (in the 6 categories described above) for each specific industry/job function combination from volumes of JDs and/or relevant resumes.

The system 1 will parse each document, using dictionary and stemming functions to select nouns, pronouns & verbs. The system 1 eliminates all noise words (all non-nouns & non-verbs), until amount of key words found reaches a ‘saturation’ state. A ‘Saturation’ state is reached when no additional new words are found, despite addition of more documents.

The system 1 will assign a weight (WW) to each word identified, by the following formula:

# of occurrence of each word, divided by # of total words identified on saturation. The Weights are calculated individually for each key word by frequency of occurrence. The Highest occurrence produces highest weight.

The system 1 will assign a hex number to each key word identified (WH) where Hex number's are assigned uniquely to each key word.

The system 1 will set up the KWL with key words identified, together with special terms compiled in steps above. The KWL is continuously updated by incoming JDs and relevant resumes, with the parsing process described above.

The system 1 will build a Key Text Library (KTL) using key words and verbs identified in above to identify key text to create KTL. The system will use key words and verbs identified in each line to create a key line—Key Text. Using similar methods for key words the system will establish saturation state of key text, calculate weight (TW) of each key text (# of occurrence divided by # of total key texts upon saturation). The individual weight of key words have no relevance to weight of key text. The system 1 will add all the WH's in a line to produce unique hex number (TH) for each key text.

The system 1 will set up the Key Text Library (KTL) with key texts identified. The KTL will be updated by incoming JDs and (relevant) resumes.

The system 1 will match incoming documents (either Job Descriptions or Resumes) with the Key Word Library and Key Text Library. The guidelines to parse incoming documents are as follows: Identify Key Words—all nouns, pronouns, verbs & any special terms,

Identify Key Text, according to the following rule: a. Noun+Verb+punctuation, or b. Noun+Verb+space (if no punctuation), c. If findings of (a) & (b) result in more than 10 key words, start a new line with every 3^{rd} verb (i.e. after 2 verbs, start a new text line). Match all words (nouns, pronouns, verbs & special terms) with Key Word Library, using hex numbers (WH). For each word matched, obtain weight (WW) from KWL. For each word not matched, add to KWL, calculate weight (WW) and assign hex # (WH). Match all lines to Key Text Library, using hex total (TH) of each line. For each line matched, obtain weight of line (TW) from KTL. For each line not matched, add to KTL, calculate weight and assign hex # of new line. Add weights of all matched key words (WW) and key texts (TW) to produce total weight of document.

The system 1 will handle specific job requirements by a recruiter, by guiding an applicant to choose from a ‘mix’ of the recruiter's specific job requirements with other criteria from the same industry/job function combination. The selections by the applicant are then adjusted with priorities assigned by recruiter to individual lines in JD, and added together to produce Score-A (Spec Score).

The system 1 will handle general job descriptions in the industry database by parsing the document. Match with key words in database by hex # (WH), and record word weight (WW). Match with key texts in database by hex total (TH), and obtain text weight (TW). The WWs and TWs are then added together to produce Score-B (Reference Score).

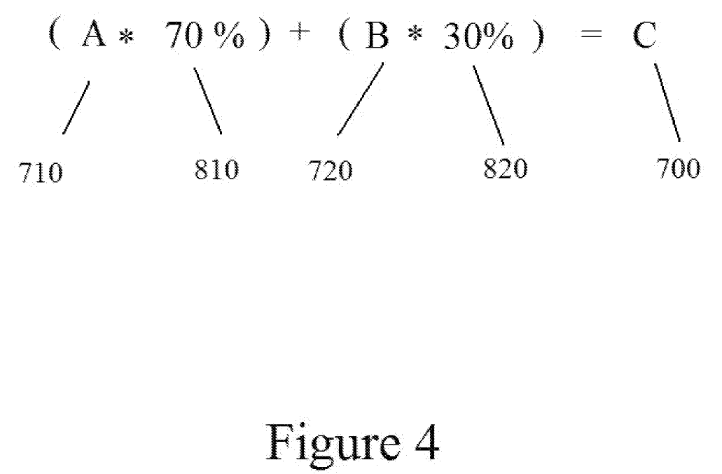

The Composite Score 700 is then calculated by taking the Spec score 710 “A” times the Spec score multiplier 810 “70%” and adding it to the Reference score 720 “B” times the Reference score multiplier 820 “30%”. This gives you the composite score 700 as shown in FIG. 4. The Spec score multiplier 810 and the Reference score multiplier 820 should add up to equal 100 percent.

FIG. 3 shows the flow of the system 1. A company 20 or multiple of companies log on to the web site 100 address of the system 1. An applicant 10 or a plurality of applicants 10 also log on to the website 100. The process creates both the Spec score 710 and the Reference score 720.

For the Spec score 710, the system 1 selects and prioritizes the job spec criteria. The company 20 and Applicant 10 register with the system 1. The Applicant 10 chooses from a group of criteria in a drop down box answers which comprises a ‘mix; of recruiter's specific requirements with other criteria from the same industry and job function combination.

With the composite score 700, the system 1 can offer a recruiter a more balanced method of comparison—one that combines a match with the specific needs of a particular position, as well as a match with what other recruiters are asking for in a similar position in the market.

### Conclusion

Although the present invention has been described in considerable detail with reference to certain preferred versions thereof, other versions are possible. Therefore, the point and scope of the appended claims should not be limited to the description of the preferred versions contained herein. The system is not limited to any particular programming language or computer platform.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A data processing system for scoring candidates comprising:
a) having a spec score,
b) having an industry score; and
c) using the industry score and the spec score to create a composite score.

2. A system according to claim 1 where said the spec score is based on a set of responsibilities, personal attributes and winning attributes.

3. A system according to claim 1 where said industry score is generated by
a) building a Key Word Library from a plurality of source documents,
b) building a Key Text Library from a plurality of source documents; and
c) comparing a plurality of incoming document against the Key Text Library and the Key Word Library.

4. A system according to claim 3 in where said Key Word Library is build by identifying key words from a document.

5. A system according to claim 4 where said document is a resume.

6. A system according to claim 3 where said reference score is based on a combination of the industry and job function.

7. A system according to claim 3 which includes the step of compiling a list of pronouns and special terms.

8. A system according to claim 3 where each document will be parsed into key words.

9. A system according to claim 3 which includes eliminating all noise words until the amount of key words reaches a saturation state.

10. A system according to claim 1 further comprising using artificial intelligent to create said spec score.

11. A system according to claim 1 further comprising using artificial intelligent to create said industry score.

12. A system according to claim 1 further comprising having a spec score multiplier for said spec score and having an industry score multiplier for said industry score.

13. A system according to claim 12 where said spec score multiplier and said industry score multiplier add up to equal 1.

14. A system according to claim 12 where said composite score is calculated by adding the spec score multiplier times the spec score and adding the industry score multiplier times the industry reference score.

15. A data processing system for scoring candidates comprising:
having a spec score, having an industry score; using the industry score and the spec score to create a composite score, where said the spec score is based on a set of responsibilities, personal attributes and winning attributes, where said industry score is generated by a) building a Key Word Library from a plurality of source documents, b) building a Key Text Library from a plurality of source documents; and c) comparing a plurality of incoming document against the Key Text Library and the Key Word Library, having a spec score multiplier for said spec score and having an industry score multiplier for said industry score where said spec score multiplier and said industry score multiplier add up to equal 1 and the composite score is calculated by adding the spec score multiplier times the spec score and adding the industry score multiplier times the industry score.

16. A system according to claim 15 in where said Key Word Library is build by identifying key words from a document.

17. A system according to claim 16 where said document is a resume.

18. A system according to claim 15 where said industry score is based on a combination of the industry and job function.

19. A system according to claim 15 further comprising using artificial intelligent to create said spec score.

20. A system according to claim 15 further comprising using artificial intelligent to create said industry score.
